(19) United States
(12) Patent Application Publication
(10) Pub. No.: US 2025/0208413 A1
(43) Pub. Date: Jun. 26, 2025

(54) OPTICAL DEVICE SUITABLE FOR ILLUMINATING THE RETINA

(71) Applicant: EYEJETS LTD., Modi'in (IL)

(72) Inventor: Joshua GUR, Jerusalem (IL)

(21) Appl. No.: 19/077,269

(22) Filed: Mar. 12, 2025

Related U.S. Application Data
(63) Continuation-in-part of application No. 18/718,290, filed on Jun. 10, 2024, now Pat. No. 12,276,801.
(60) Provisional application No. 63/408,562, filed on Sep. 21, 2022.

(51) Int. Cl. G02B 27/00; G02B 27/01; G02B 27/09

(52) U.S. Cl. CPC G02B 27/0093; G02B 27/0172; G02B 27/0955; G02B 2027/013

(57) ABSTRACT

Disclosed are optical devices suitable for illuminating the retina. Some embodiments of such optical devices are useful for use in implementing eye trackers and/or virtual retinal displays.

### RELATED APPLICATION

The instant application is a Continuation-In-Part of U.S. Ser. No. 18/718,290 filed Jun. 10, 2024 which was published on Feb. 20, 2025 as US 2025/0060591 which is a US National Phase of PCT/IL2023/051023 having an International Filing Date of Sep. 21, 2023 which was published on 28 Mar. 2024 as WO2024/062483 and takes priority from U.S. 63/408,562 filed Sep. 21, 2022, all three being included by reference as if fully set forth herein

### FIELD AND BACKGROUND OF THE INVENTION

The invention, in some embodiments, relates to the field of optical devices and more particularly, but not exclusively, to optical devices suitable for illuminating the retina. Some embodiments of such optical devices are useful for use in implementing eye trackers and/or virtual retinal displays.

A virtual retinal display (VRD) is a device whereby an image is displayed to a person by drawing the image on the retina with laser light, for example using a raster scan. The image can be a monochromatic-image (when a single laser having a single color is used to draw the image) or a color-image (when multiple lasers, e.g., a red, a green and a blue laser are concurrently used to draw the image). Typically, a complete image is drawn on the retina at a rate of at least 30 Hz, more preferably at least 60 Hz so that the person perceives the image. VRD can be applied to a single eye of a person, or simultaneously to both eyes. When applied to both eyes, identical images can be drawn on the two eyes, a stereoscopic pair of images can be drawn on the two eyes, or different images can be drawn on the two eyes. A series of succeeding images can be a single image (still) displayed for an extended period of time or the series of succeeding images can constitute a video.

A VRD comprises two units: an eye tracker and a VRD display unit.

The eye tracker tracks the position of the eye, preferably at a rate at least as fast as the rate of display of the images.

The display unit draws the desired image with one or more lasers on the retina with reference to the position of the eye determined by the eye tracker to compensate for eye movement to ensure that the individual images of a series of image are drawn at the same location on the retina.

In PCT publication WO 2021/064734, the Inventor has disclosed an optical device suitable for use as both an eye tracker (for whatever purpose, including as a VRD eye tracker) and as a VRD display unit.

### SUMMARY OF THE INVENTION

The invention, in some embodiments, relates to the field of optical devices and more particularly, but not exclusively, to optical devices suitable for illuminating the retina. Some embodiments of such optical devices are useful for use in implementing eye trackers and/or VRD display units.

According to an aspect of some embodiments of the teachings herein, there is provided a method of displaying an image to a person, comprising:
with a VRD device, displaying an image to a person by drawing the image on a retina of
the person with beams of laser light,
   wherein the beams of laser light that make up the entire the image all pass through a portion of the pupil of the person that has a smaller than the pupillary cross-sectional diameter thereby achieving an optical pinhole effect. In some embodiments, the portion of the pupil through which all the beams of light pass has a cross section of not more than about 1.23 mm². In some embodiments, the portion of the pupil through which all the beams of light pass has a cross section of not more than about 0.8 mm².

According to an aspect of some embodiments of the teachings herein, there is also provided a VRD device for displaying an image to a person by drawing the image on a retina of the person with beams of laser light,

wherein the device comprises an arrangement of optical elements such that beams of laser light that make up the entire image all pass through a portion of the pupil of the person that has a smaller than the pupillary cross-sectional diameter, thereby achieving an optical pinhole effect. In some embodiments, the portion of the pupil through which all the beams of light pass has a cross section of not more than about 1.23 mm². In some embodiments, the portion of the pupil through which all the beams of light pass has a cross section of not more than about 0.8 mm².

In some embodiments, the arrangement of optical elements includes one or more optical elements, at least one the optical element is selected from the group consisting of a convexly curved mirror, a flat mirror, a prism and a convex lens.

According to an aspect of some embodiments of the teachings herein, there is also provided a VRD device, comprising:
a wearable frame,
a laser for emitting a beam of light having a wavelength λ₁, attached to the frame,
a MEMS mirror system comprising a moveable mirror attached to the frame,
a convex focusing lens attached to the frame, and
a curved mirror attached to the frame, wherein the curved mirror is located in front of an eye of a wearer and covering at least part of the field of view thereof,
   wherein the device is configured so that beams of light emitted from the laser are reflected by the movable mirror, through the convex focusing lens to be reflected from the curved mirror through the pupil of an eye of a wearer to illuminate a portion of the retina of the eye,
   wherein the device comprises an arrangement of optical elements including the convex focusing lens and the curved mirror, such that the beams of laser light that make up an entire image all pass through a portion of the pupil of a wearer that has a smaller than the pupillary cross-sectional diameter, thereby achieving an optical pinhole effect. In some embodiments, the portion of the pupil through which all the beams of light pass has a cross section of not more than about 1.23 mm². In some embodiments, the portion of the pupil through which all the beams of light pass has a cross section of not more than about 0.8 mm².

In some embodiments, subsequent to passing through the convex focusing lens and prior to being reflected from the curved mirror through the pupil of an eye, the beams of light are at least one of: reflected from at least one additional concavely-curved mirror; reflected from at least one additional non-curved mirror; and pass through at least one additional convex focusing lens.

Additional aspects and embodiments of the invention are described in the specification hereinbelow and in the appended claims.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

### In the Figures:

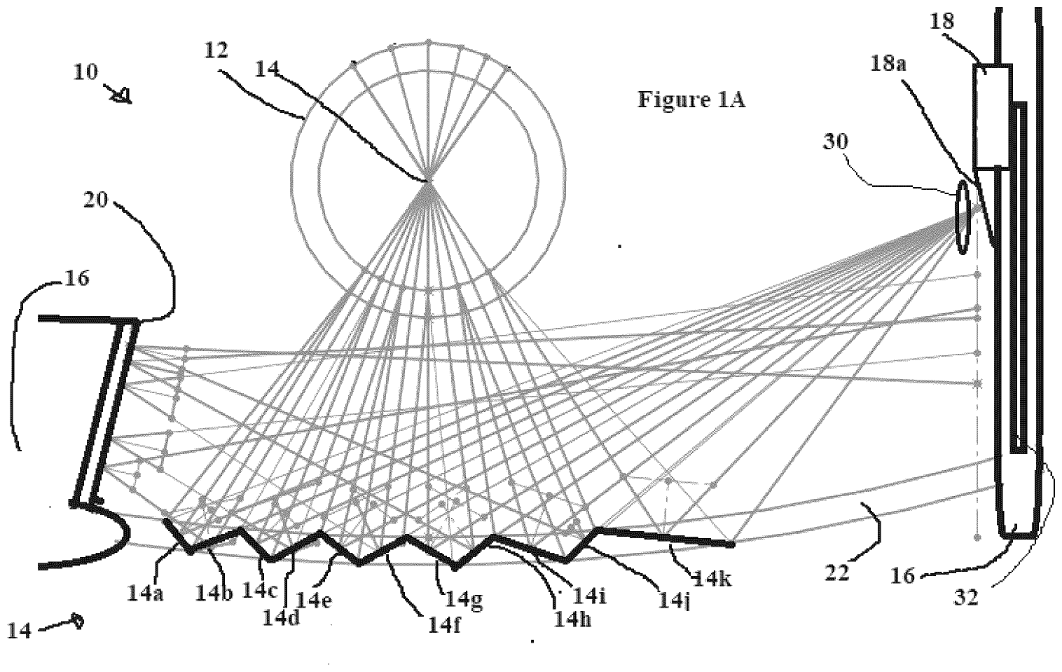

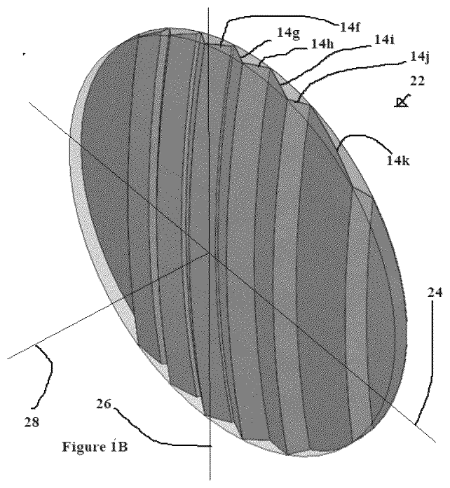

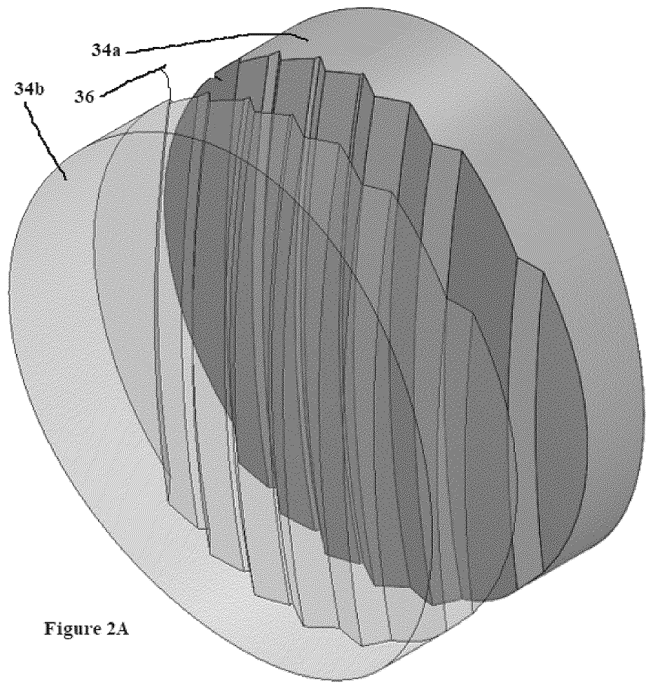

FIGS. 1A and 1B schematically depict an embodiment of a device according to the teachings herein;

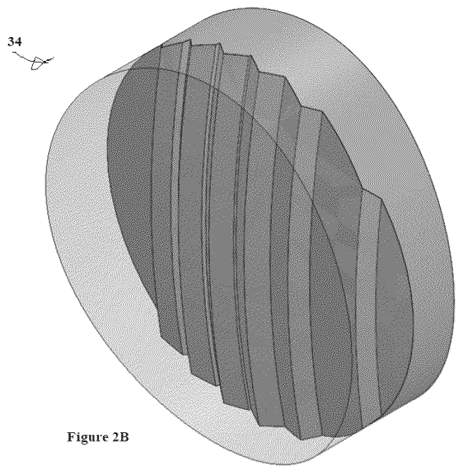

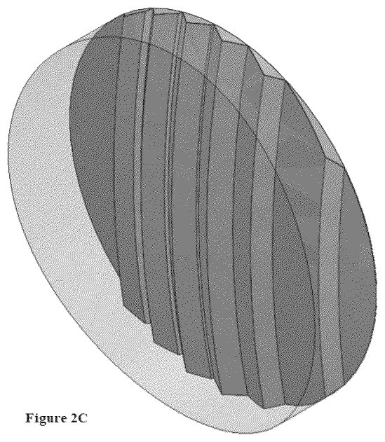

FIGS. 2A, 2B and 2C schematically depict steps in the construction of a set of mirrors of an embodiment of a device according to the teachings herein; and

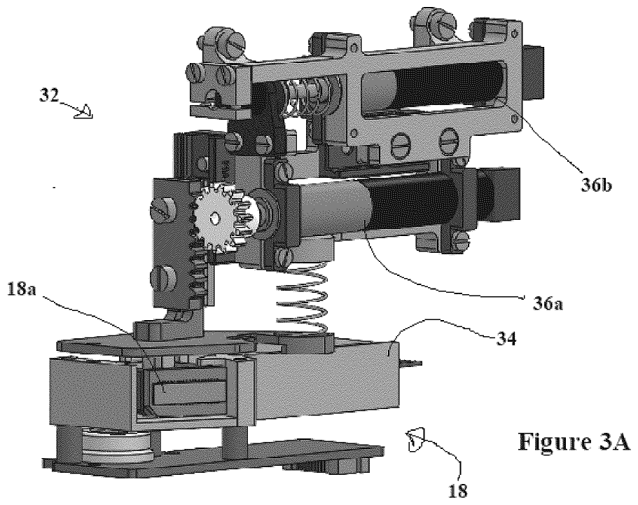

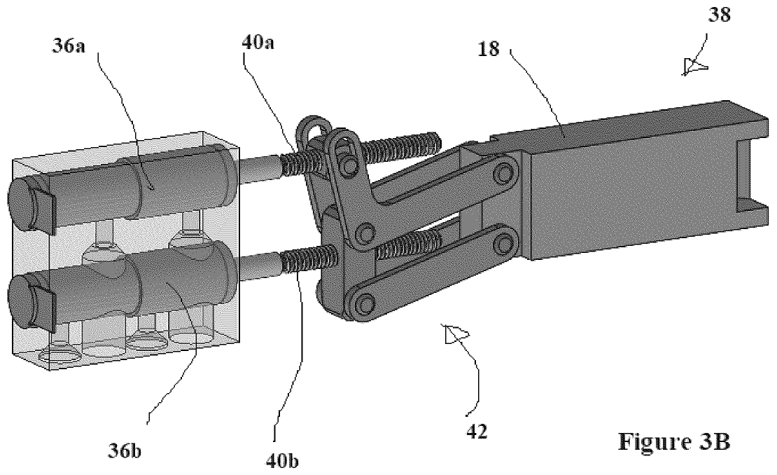

FIGS. 3A and 3B depict embodiments of a translation mechanisms of a device according to the teachings herein.

### DESCRIPTION OF SOME EMBODIMENTS OF THE INVENTION

The invention, in some embodiments, relates to the field of optical devices and more particularly, but not exclusively, to optical devices suitable for illuminating the retina. Some embodiments of such optical devices are useful for use in implementing eye trackers and/or VRD display units.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

As noted above, VRD requires illuminating the retina. Typically, the retina is illuminated using a laser which directs an appropriately intensity-modulated beam of light at the movable mirror of a MEMS mirror system (such as available from Hamamatsu Photonics KK, Hamamatsu City, Shizuoka, Japan). The movable mirror is moved by a computer processor to direct the laser light through the pupil to a desired location on the retina. Typically, the laser and the mirror are fixedly attached to a wearable frame, such as an eyeglass frame, that is worn by a user. As is known, the optical axis of the eye continuously moves relative to the head of the user and consequently relative to the worn frame. When all factors are considered, it is challenging to provide an optical device that is attached to a wearable frame that can direct laser light through a pupil to illuminate the retina while the optical axis of the eye moves.

As used herein, the planes of the head of a person are define as follows:
the sagittal plane separates the left from the right;
the frontal plane separates the front from the back; and the transverse plane separates the top from the bottom.
   As used herein, the axes of the head of a person are define as follows:
the sagittal axis (forwards/back) is perpendicular to the frontal plane;
the frontal axis (left/right) is perpendicular to the sagittal plane; and
the longitudinal axis (up/down) is perpendicular to the transverse plane.

Herein is disclosed an optical device comprising a frame wearable by a user (e.g., a human user) having:
a vertical axis perpendicular to a horizontal plane of the frame,
a horizontal axis perpendicular to a sagittal plane of the frame, and
a sagittal axis perpendicular to a vertical plane of the frame.
   When the frame is worn:
the vertical axis of the frame is substantially parallel to the longitudinal axis and substantially perpendicular to the transverse plane of the head of the wearer;
the horizontal axis of the frame is substantially parallel to the frontal axis and substantially perpendicular to the sagittal plane of the head of the wearer; and
the sagittal axis of the frame is substantially parallel to the sagittal axis and substantially perpendicular to the frontal plane of the head of the wearer.
   The gaze direction of a wearer who looks straight ahead is substantially perpendicular to the frontal plane of the device and of the head, and is substantially parallel to the sagittal axis of the device and of the head. As used above, “substantially parallel” and “substantially perpendicular” are respectively parallel and perpendicular within the deviation of the normal wearing of eyeglasses, as is known to a person having ordinary skill in the art of optometry.

The device further comprises, attached to the frame:
a laser for emitting a beam of light having a wavelength λ₁;
a MEMS mirror system comprising a movable MEMS mirror; and
a set of at least two curved mirrors attached to the frame,
   wherein the set of curved mirrors is attached to the frame so as to be located in front of an eye of a person wearing the frame (a wearer) and covering at least part of the field of view thereof, analogously to the location of the lens of eyeglasses.

The device is configured to allow reflection of light from the laser by the movable mirror to a selected mirror of the set of mirrors, and from the selected mirror through the pupil of a wearer to illuminate the retina of the eye, the selected mirror being a mirror of the set that allows reflection of light through the pupil of the wearer to illuminate the retina.

In some embodiments, the optical device comprises at least two lasers, a first laser as described above for emitting a beam of light having a wavelength λ₁, and a second laser as described above for emitting a beam of light having a wavelength λ₂. In some such embodiments, the optical device comprises a third laser for emitting a beam of light having a wavelength λ₃. In some such embodiments, the optical device comprises a fourth laser for emitting a beam of light having a wavelength λ₄.

In some embodiments, one or more of the mirrors of the set of mirrors is a broadband reflective mirror. In typical such embodiments, the mirror is opaque or distorts vision therethrough.

In some preferred embodiments, one, more than one and, in preferred embodiments all of the mirrors of the set of mirrors are wavelength-selective mirrors. A wavelength-selective mirror is a mirror that reflects substantially only light having wavelengths of the one or more lasers of the device. In some embodiments, for each laser emitting a beam of light having a wavelength λ, the wavelength-selective mirror reflects not less than 90% of light having λ±4 nm, preferably not less than 90% of light having λ±3 nm, more preferably not less than 90% of light having λ±2 nm, and even more preferably not less than 90% of light having λ±1 nm. In some such embodiments, the wavelength-selective mirror is therefore substantially transparent, that is to say, that a wearer can see through the wavelength-selective mirror with little or no color distortion. Such wavelength-selective mirrors (e.g., reflecting only one, only two, only three, or only four wavelengths) can be made using any suitable technology, for example, commercially-available technologies from S1 Optics GmbH, Nürtingen, Germany and from CVI Laser, LLC, Albuquerque, New Mexico, USA.

In preferred embodiments, a curved mirror comprises one or more reflective layers on a curved surface of a mirror support, e.g., of glass or plastic such as polycarbonate or PMMA, especially as known in the art as being suitable for making lenses of eyeglasses. In such embodiments, the one or more reflective layers adopt the curvature of the curved surface of the mirror support. In such embodiments, the curved surface is appropriately curved (as discussed in detail below). In some embodiments, at least one reflective layer is on a curved surface that is an inner face of the support (i.e., the side of the support that is close to the eye of a wearer). Additionally, or alternatively, in some embodiments, at least one reflective layer is on a curved surface that is an outer face of the support (i.e., the side of the support that is far from the eye of a wearer). The mirrors and mirror support together have any suitable thickness, preferably as thin as possible. In some preferred embodiments, the mirrors and mirror support are not more than about 10 mm thick, not more than about 8 mm, not more than about 6 mm, not more than about 4 mm and even not more than about 2 mm thick.

In the sagittal plane, the curved mirrors of the set of mirrors are concavely curved (e.g., spherically, elliptically, aspherically) to account for changes in the elevation of the pupil (i.e., deviation of the gaze direction of the eye from parallel to the transverse plane of the head). Specifically, the curvature of the curved mirrors in the sagittal plane of the device is such that changes in the elevation of the pupil are accounted for by changes in the elevation of the MEMS mirror and therefore the vertical location of the curved mirror from which the light is reflected through the pupil.

Typically, a beam of light emitted from a laser of the device has a diameter of about 1 mm. In some preferred embodiments, the device further comprises a convex focusing lens positioned so that laser light that is reflected from the movable MEMS mirror passes through the convex focusing lens prior to reaching a curved mirror of the set of mirrors. In preferred embodiments, the optical power of the convex focusing lens is such that a 1 mm diameter laser beam that is:
reflected from the MEMS mirror, passes through the convex focusing lens to be reflected from a curved mirror of the set of mirrors to pass through the pupil, illuminates a portion of the retina having a diameter of not more than 30 micrometers and even more preferably not more than 20 micrometers, for example, about 10-15 micrometers.

Further, in preferred embodiments, the components of the device are configured such that the beams of light that make-up an entire image that is displayed on the retina using the device for VRD all pass through a portion of the pupil that has a smaller than the pupillary cross sectional diameter (e.g., a portion of the pupil that has cross section of not more than about 1.23 mm² and even not more than about 0.8 mm². so that the configuration provides an optical pinhole effect.

The teachings herein will be described with reference to an embodiment of a device according to the teachings herein, device 10, schematically depicted in FIGS. 1A and 1B.

In FIG. 1A, device 10, is depicted in a cross section in the horizontal plane viewed from above along the vertical axis, with an eye 12 of a wearer, the eye having a center of rotation 14.

When device (10) is worn, the set (14) of curved mirrors (14a-14k) is located in front of the eye (12) of a person wearing the frame (16). Further, the set of mirrors (14) is bracketed between the MEMS mirror (18a) of the MEMS system (18) and an intermediate mirror (20).

In preferred embodiments such as depicted in FIG. 1A, the MEMS mirror (18a) is temporal (near the temple) and the intermediate mirror (20) is nasal (near the nose) relative to the set of mirrors (14), In some non-depicted alternative embodiments, the MEMS mirror is nasal and the intermediate mirror is temporal relative to the set of lenses.

The mirrors of set of mirrors (14) are all thin layers of wavelength-selective reflective material on a curved surfaces of a mirror support 22 of optical-grade polycarbonate.

The curved mirrors (14a-14k) are all substantially vertically-oriented strips that in the horizontal planes are linear and arranged side-to-side with neighboring curved mirrors to constitute the set of mirrors (14). Two end curved mirrors 14a and 14k each have a single neighboring curved mirror while the other curved mirrors (14b-14j) each have two neighboring curved mirrors. The angle of each curved mirror in the horizontal plane relative to the frontal plane is such that the curved mirrors alternatingly face the MEMS mirror (18a) and the intermediate mirror (20), from above giving the set of mirrors 14 the appearance of concertina-folded paper. Specifically curved mirrors 14a, 14c. 14e, 14g, 14i and 14k face the MEMS mirror (18a) and curved mirrors 14b, 14d, 14f, 14h and 14j face intermediate mirror (20).

The angle of each individual curved mirror (14a-14k) in the transverse plane relative to the frontal plane is constant.

For the curved mirrors 14a, 14c. 14e, 14g, 14i and 14k facing the MEMS mirror (18), the angle in the horizontal plane relative to the frontal plane is increasingly acute the further the curved mirror is from the MEMS mirror (18a).

For the curved mirrors 14b, 14d, 14f, 14h and 14j facing the intermediate mirror (20), the angle in the horizontal plane relative to the frontal plane is increasingly acute the further the curved mirror is from the intermediate mirror (20).

Similarly to the curved mirrors (14a-14k) of the set of mirrors 14, the intermediate mirror (20) is also a substantially-vertically oriented strip that is linear in the horizontal plane.

In FIG. 1B, mirror support 22 with set of mirrors 14 is depicted in perspective view, with a horizontal axis 24, vertical axis 26 and sagittal axis 28 which is also the direction of gaze of eye 12 when gazing straight ahead. A distal side of mirror support 22 (that faces the viewer in FIG. 1B) and faces away from a wearer of device 10 is of polycarbonate. The proximal side of mirror support 22 that faces a wearer of device 10 bears the curved surfaces that support the reflective material to constitute mirrors 14a-14k of set of mirrors 14.

As is seen in FIG. 1B, curved mirrors (14a-14k) are concavely-curved relative to the frontal plane. Although not depicted, intermediate mirror 20 is analogously curved relative to the sagittal plane.

The exact relative physical position of the MEMS mirror (18), the intermediate mirror (20), and the curved mirrors of the set of mirrors as well as the dimensions, angles and curvatures are selected so that for a wide range of gaze directions of the eye of the wearer, MEMS mirror (18) can be oriented so as to reflect light emitted by the laser either:
towards a selected one of the curved mirrors 14a, 14c. 14e, 14g, 14i and 14k of the set of mirrors 14 facing the MEMS mirror to be reflected from the selected curved mirror through the pupil of the eye to illuminate the retina of the eye; or
towards the intermediate mirror, to be reflected from the intermediate mirror towards a selected one of the curved mirrors 14b, 14d, 14f, 14h and 14j of the set of mirrors 14 facing the intermediate mirror to be reflected from the selected curved mirror through the pupil of the eye to illuminate the retina of the eye.
   Further, the device is configured so that the light paths described above pass between the reflective surfaces of the curved mirrors and parts of the wearer's body.

In FIG. 1A, intermediate mirror 20 is linear in the horizontal plane. In some embodiments, intermediate mirror 20 is concavely curved (e.g., spherically curved, elliptically or aspherically curved) facing the curved mirrors.

An additional component that is depicted in FIG. 1A is convex focusing lens 30 which is physically-associated with MEMS mirror (18a) so that light reflected by MEMS mirror (18a) towards intermediate mirror (20) or curved mirrors (14a-14k) first passes through convex focusing lens 30.

Further, MEMS system 18, including MEMS mirror 18a and focusing lens 30, are mounted on translation mechanism 32. Translation mechanism 32 is configured to move MEMS system 18, including MEMS mirror 18a and focusing lens 30 back and forth parallel to the sagittal axis and up and down parallel to the vertical axis. The translation mechanism 32 increases the range of incident angles with which MEMS mirror 18a can direct light towards curved mirrors 14a-14k and intermediate mirror 20. The range of motion of translation mechanism 32 parallel to the vertical axis is +5 mm from the visual axis of eye 12 of a wearer. The range of motion of translation mechanism 32 in the horizontal plane parallel to the sagittal axis is 10 mm.

In FIG. 1A are also depicted multiple rays, showing how light emitted from a laser is reflected by MEMS mirror 18a through convex focusing lens 30 towards either:
any of curved mirrors 14a, 14c. 14e, 14g, 14i and 14k, to be reflected therefrom towards a center of rotation 14 of eye 12 and, if the pupil of eye 12 was correctly oriented, to illuminate a portion of the retina of eye 12; or
intermediate mirror 20 to be reflected therefrom towards any of curved mirrors 14b, 14d, 14f, 14h and 14j to be reflected therefrom towards a center of rotation 14 of eye 12 and, if the pupil of eye 12 was correctly oriented, to illuminate a portion of the retina of eye 12.

To illuminate a specific desired portion of retina 12, the controller of MEMS system 18 directs MEMS mirror 18a to reflect the light emitted from a laser towards an appropriate one of curved mirrors 14a-14k. In some instances, it is necessary to move MEMS system 18 using translation mechanism 32 forwards or back and/or up or down to an appropriate position on frame 16. For example, from the position depicted in FIG. 1A, it is necessary to move MEMS system 18 forwards to an appropriate position in order to illuminate portions of the retina with curved mirrors 14b, 14d, 14f, 14h and 14j via the intermediate mirror 20.

Further, in preferred embodiments, the components of the device are configured such that the beams of light that make-up an entire image that is displayed on the retina using the device for VRD all pass through a portion of the pupil that has a smaller than the pupillary cross-sectional diameter (as described above) so that the configuration provides an optical pinhole effect.

As noted above and depicted in FIG. 1B, a distal side of mirror support 22 (that faces the viewer in FIG. 1B) and faces away from a wearer of device 10 is of polycarbonate while the proximal side of mirror support 22 that faces a wearer of device 10 bears the curved surfaces that support the reflective material to constitute mirrors 14a-14k of set of mirrors 14.

In some embodiments, the reflective material is covered with a proximal cover. A proximal cover is a component that has an inner side that is shaped to mate with the proximal side of the mirror support and the reflective surface. Such a proximal cover physically protects the set of curved mirrors, preventing degradation of the reflective properties of the mirrors, and providing the “lens” of the optical device an appealing form. Such a proximal cover is made of any suitable material. Generally, material having a lower index of refraction are preferred, for example, material having an index of refraction not more than about 1.4, not more than about 1.35 and even not more than about 1.3 such as Teflon AF (index of refraction=1.26).

The construction of such a “lens” is schematically depicted in FIGS. 2A, 2B, 2C and FIG. 1B.

In FIG. 2A, a surface of two workpieces 34a (Teflon AF) and 34b (polycarbonate) are precision made (e.g., by molding and/or machining) to have the desired shape of curved mirrors (14a-14k) of mirror set 14. On a surface 36 of polycarbonate workpiece 34b is deposited (e.g., vapor deposition) a thin layer of wavelength-selective reflecting material for each wavelength λ that it is desired that mirror set 14 will reflect, in some embodiments, one, two, three, four or even more different layers are deposited to reflect one, two, three, four or even more different respective wavelengths.

In FIG. 2B, workpieces 34a and 34b are fixedly attached, e.g., by welding to make a single block 34 with mirror set 14 embedded therein.

First one face of block 34 (FIG. 2C) then the other (FIG. 1B) is machined and polished to provide the “lens” having the desired shape with mirror set 14 embedded therein.

In some alternative embodiments, the “lens” comprises a mirror support (22) with the reflective layers constituting the curved mirrors with a protective coating covering the reflective layers. Any suitable coating can be used, for example, a coating of parylene, especially a coating of parylene E which can be applied as a 400 nm to 10 micrometer thick layer.

Additionally or alternatively to the protective coating, in some embodiments, covering the inner face of the lens is a thin foil transparent at least to the wavelengths of the laser or lasers of the device, e.g., a foil of PMMA not more than 200 micrometers thick. Such a foil is preferably supported by and even attached to (e.g., by welding) the vertices between the neighboring curved mirrors. In the volume between the inner side of the foil and the reflective surface of the curved mirrors is a gas, for example, air, nitrogen or argon.

### Translation Mechanism

In FIG. 3A, translation mechanism 32 is depicted including MEMS system 18 with a movable MEMS mirror 18a (seen from the back) and an associated laser 34, a first micromotor 36a with associated gearing to translate MEMS system 18 (together with laser 34 and a non-depicted focusing lens) up and down in parallel to the vertical axis and a second micromotor 36b with associated gearing to translate MEMS system 18 and first micromotor 36a forwards and back parallel to the sagittal axis. In

In FIG. 3B, a second specific embodiment of a translation mechanism 38 is depicted including MEMS system 18 (the associated MEMS mirror, laser and focusing lens are not depicted), two micromotors 36a and 36b for rotating screws 40a and 40b, respectively and a four-bar linkage 42 linking rotating screws 40a and 40b with MEMS system 18. As is apparent to a person having ordinary skill in the art, when micromotors 36a and 36b together rotate screws 40 and 40b at the same rate in the same direction, four-bar linkage 42 and MEMS system 18 are translated forwards or back parallel to the sagittal axis. When micromotors 36a and 36b rotate at different rates and/or in different directions, the bars of four-bar linkage 42 rotate around the four joints, thereby translating MEMS system 18 up and down in parallel to the vertical axis without tilting MEMS system 18, optionally simultaneously translating four-bar linkage 42 and MEMS system 18 forwards or back parallel to the sagittal axis.

Suitable micromotors for implementing a translation mechanism of a device according to the teachings herein include micromotors commercially available from Dr. Fritz Faulhaber GmbH & Co. KG (Schönaich, Germany)

The speed of the motion of the translation mechanism is any suitable speed. In preferred embodiments, the speed is such that the translation mechanism can move from one position to any other position in less than 100 milliseconds.

Both depicted translation mechanisms are configured to move the MEMS system back and forth parallel to the sagittal axis and up and down parallel to the vertical axis.

In some alternative embodiments, a device comprises a translation mechanism configured to move the MEMS system back and forth parallel to the sagittal axis without any movement parallel to the vertical axis. In preferred such embodiments, the range of motion of translation mechanism 32 in the horizontal plane parallel to the sagittal axis is 10 mm.

In some alternative embodiments, a device comprises a translation mechanism configured to move the MEMS system in the horizontal plane, but not parallel to the sagittal axis. In preferred such embodiments, the range of motion of translation mechanism 32 in the horizontal plane parallel to the sagittal axis is 10 mm. For example, in some embodiments, the motion of the MEMS system curves inwards towards the curved lens, so that when furthest from the set of curved lens the motion is parallel to the sagittal axis and closest to the set of curved lens the motion deviates inwards. Such inwards deviation is any suitable inwards deviation, in some embodiments between about 4° and about 14°, for example between about 6° and about 12°.

In some alternative embodiments, a device comprises a translation mechanism configured to move the MEMS system up and down parallel to the vertical axis without any movement parallel to the sagittal axis. In such embodiments, the range of motion of translation mechanism 32 parallel to the vertical axis is +5 mm from the visual axis of eye 12 of a wearer.

In some alternative embodiments, a device according to the teachings herein is devoid of a translation mechanism and the MEMS system is fixedly attached to the frame. In preferred such embodiments, the center of MEMS mirror 18a is within about 5 mm from the visual axis of eye 12 of a wearer.

### Rotation Mechanism

As noted above, in some embodiments a device comprises a translation mechanism configured to move the MEMS system back and forth parallel to the sagittal axis. Additionally or alternatively, in some embodiments a device comprises a translation mechanism configured to move the MEMS system up and down parallel to the vertical axis.

Additionally or alternatively to any translation mechanism, in some embodiments, a device comprises a MEMS rotation mechanism, the MEMS rotation mechanism configured to, under control of a control unit of the device, rotate the MEMS in the horizontal plane. Such a MEMS-rotation mechanism provides the device with a greater number of potential optical paths and also allows reflecting laser light from the MEMS mirror at an advantageous angle, e.g., in some embodiments at a steep angle rather than a shallow angle.

### Alternative Embodiments

In the embodiment discussed above, the angle of each curved mirror in the horizontal plane relative to the frontal plane is such that the curved mirrors alternatingly face MEMS mirror 18a and the intermediate mirror 20, Specifically curved mirrors 14a, 14c. 14e, 14g, 14i and 14k facing MEMS mirror 18a and curved mirrors 14b, 14d, 14f, 14h and 14j facing intermediate mirror 20.

In some alternative embodiments, the angle of each curved mirror in the horizontal plane relative to the frontal plane is such that all of the curved mirrors face the MEMS mirror. In some such embodiments, the device is devoid of an intermediate mirror.

Similarly, in some alternative embodiments, the angle of each curved mirror in the horizontal plane relative to the frontal plane is such that all of the curved mirrors face an intermediate mirror.

As is understood from the description and accompanying figures, embodiments of the optical device according to the teachings herein allows directing light emitted from a laser to illuminate the retina of an eye when the optical axis of the eye is directed in different directions.

### Optical Pinhole Effect

It is known to increase the depth of field of image acquisition by allowing light making up an image to reach a detector only through a pinhole (a small aperture) in a barrier to light transmission.

Herein is disclosed methods and devices for achieving a pinhole effect of increased depth of field similar or identical to that of using a pinhole in a light barrier but instead of a barrier is achieved by configuring the various components of the device (laser, mirrors, lenses) ensuring that the beams of light that make-up the entire image that is displayed on the retina all pass through a portion of the pupil that has a smaller than the pupillary cross-sectional diameter so that the configuration provides an optical pinhole effect.

When used in the context of an optical device according to the teachings herein, the pinhole effect overcomes at least some of the problems of accommodation and/or convergence of the two eyes when applicable.

According to an aspect of some embodiments of the teachings herein, there is provided a method of displaying an image to a person, comprising:
with a VRD device, displaying an image to a person by drawing the image on a retina of the person with beams of laser light,
   wherein the beams of laser light that make up the entire image all pass through a portion of the pupil of the person that has a smaller than the pupillary cross-sectional diameter, thereby achieving an optical pinhole effect.

Accordingly, in an aspect of some embodiments of the teachings herein, there is also provided a VRD device for displaying an image to a person by drawing the image on a retina of the person with beams of laser light,

wherein the device comprises an arrangement of optical elements such that the beams of laser light that make up the entire image all pass through a portion of the pupil of the person that has a smaller than the pupillary cross-sectional diameter, thereby achieving an optical pinhole effect.

The arrangement of optical elements includes one or more optical elements. In some embodiments at least one optical element is selected from the group consisting of a convexly curved mirror, a flat mirror, a prism and a convex lens.

For the method and the device, in some embodiments, the portion of the pupil through which all the beams of light pass has a cross section of not more than about 1.23 mm² (equivalent to a circle having a 1.25 mm diameter) and even a cross section of not more than about 0.8 mm² (equivalent to a circle having a 1 mm diameter).

In some embodiments, a suitable such VRD device is a VRD device, comprising:
a wearable frame,
a laser for emitting a beam of light having a wavelength λ₁, attached to the frame,
a MEMS mirror system comprising a movable mirror attached to the frame,
a convex focusing lens attached to the frame, and
a curved mirror attached to the frame, wherein the curved mirror is located in front of an eye of a wearer and covering at least part of the field of view thereof,
   wherein the device is configured so that beams of light emitted from the laser are reflected by the movable mirror, through the convex focusing lens to be reflected from the curved mirror through the pupil of an eye of a wearer to illuminate a portion of the retina of the eye,
   wherein the device comprises an arrangement of optical elements including the convex focusing lens and the curved mirror, such that the beams of laser light that make up an entire image all pass through a portion of the pupil of a wearer that has a smaller than the pupillary cross-sectional diameter, thereby achieving an optical pinhole effect.

In some embodiments, subsequent to passing through the convex focusing lens and prior to being reflected from the curved mirror through the pupil of the eye, the beams of light are at least one of:
reflected from at least one additional concavely-curved mirror;
reflected from at least one additional non-curved mirror; and
pass through at least one additional convex focusing lens.

Unless otherwise defined, all technical and scientific terms used herein have the same meaning as commonly understood by one of ordinary skill in the art to which the invention pertains. In case of conflict, the specification, including definitions, takes precedence.

As used herein, the terms “comprising”, “including”, “having” and grammatical variants thereof are to be taken as specifying the stated features, integers, steps or components but do not preclude the addition of one or more additional features, integers, steps, components or groups thereof.

As used herein, the indefinite articles “a” and “an” mean “at least one” or “one or more” unless the context clearly dictates otherwise.

As used herein, when a numerical value is preceded by the term “about”, the term “about” is intended to indicate +/−10%.

As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C).

Embodiments of methods and/or devices described herein may involve performing or completing selected tasks manually, automatically, or a combination thereof. Some methods and/or devices described herein are implemented with the use of components that comprise hardware, software, firmware or combinations thereof. In some embodiments, some components are general-purpose components such as general-purpose computers or digital processors. In some embodiments, some components are dedicated or custom components such as circuits, integrated circuits or software.

For example, in some embodiments, some of an embodiment is implemented as a plurality of software instructions executed by a data processor, for example which is part of a general-purpose or custom computer. In some embodiments, the data processor or computer comprises volatile memory for storing instructions and/or data and/or a non-volatile storage, for example, a magnetic hard-disk and/or removable media, for storing instructions and/or data. In some embodiments, implementation includes a network connection. In some embodiments, implementation includes a user interface, generally comprising one or more of input devices (e.g., allowing input of commands and/or parameters) and output devices (e.g., allowing reporting parameters of operation and results.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1. A method of displaying an image to a person, comprising:
with a VRD device, displaying an image to a person by drawing said image on a retina of the person with beams of laser light,
wherein said beams of laser light that make up the entire said image all pass through a portion of the pupil of the person that has a smaller than the pupillary cross-sectional diameter thereby achieving an optical pinhole effect.

2. The method of claim 1, wherein said portion of the pupil through which all said beams of light pass has a cross section of not more than about 1.23 mm².

3. The method of claim 1, wherein said portion of the pupil through which all said beams of light pass has a cross section of not more than about 0.8 mm².

4. A VRD device for displaying an image to a person by drawing the image on a retina of the person with beams of laser light,
wherein the device comprises an arrangement of optical elements such that beams of laser light that make up the entire image all pass through a portion of the pupil of the person that has a smaller than the pupillary cross-sectional diameter, thereby achieving an optical pinhole effect.

5. The device of claim 4, wherein said arrangement of optical elements includes one or more optical elements, at least one said optical element is selected from the group consisting of a convexly curved mirror, a flat mirror, a prism and a convex lens.

6. The device of claim 4, wherein the portion of the pupil through which all said beams of light pass has a cross section of not more than about 1.23 mm².

7. The device of claim 4, wherein the portion of the pupil through which all said beams of light pass has a cross section of not more than about 0.8 mm².

8. A VRD device, comprising:
a wearable frame,
a laser for emitting a beam of light having a wavelength λ₁, attached to said frame,
a MEMS mirror system comprising a moveable mirror attached to said frame,
a convex focusing lens attached to said frame, and
a curved mirror attached to said frame, wherein said curved mirror is located in front of an eye of a wearer and covering at least part of the field of view thereof,
wherein the device is configured so that beams of light emitted from said laser are reflected by said movable mirror, through said convex focusing lens to be reflected from said curved mirror through the pupil of an eye of a wearer to illuminate a portion of the retina of the eye,
wherein the device comprises an arrangement of optical elements including said convex focusing lens and said curved mirror, such that the beams of laser light that make up an entire image all pass through a portion of the pupil of a wearer that has a smaller than the pupillary cross-sectional diameter, thereby achieving an optical pinhole effect.

9. The device of claim 8, wherein subsequent to passing through said convex focusing lens and prior to being reflected from said curved mirror through the pupil of an eye, the beams of light are at least one of:
reflected from at least one additional concavely-curved mirror;
reflected from at least one additional non-curved mirror; and
pass through at least one additional convex focusing lens.

10. The device of claim 8, wherein the portion of the pupil of an eye through which all said beams of light pass has a cross section of not more than about 1.23 mm².

11. The device of claim 8, wherein the portion of the pupil of an eye through which all said beams of light pass has a cross section of not more than about 0.8 mm².
